(19) United States
(12) Patent Application Publication
(10) Pub. No.: US 2003/0051757 A1
(43) Pub. Date: Mar. 20, 2003

(54) Check valve for fuel pump

(76) Inventors: Robert A. Roth, Grand Blanc, MI (US); John Gardner Fischer, Goodrich, MI (US)

Correspondence Address: VINCENT A. CICHOSZ, DELPHI TECHNOLOGIES, INC., P.O. Box 5052, Mail Code: 480-414-420, Troy, MI, 48007-5052, US

(21) Appl. No.: 09/972,289

(22) Filed: Sep. 20, 2001

(51) Int. Cl. F16K 15/00

(52) U.S. Cl. 137/541

(57) ABSTRACT

A check valve for a fuel pump of a vehicle includes a valve housing adapted to be disposed in an outlet member of the fuel pump. The valve housing has a valve seat formed thereon. The check valve also includes a valve member adapted to be disposed in the outlet member and cooperating with said valve seat. The check valve further includes a nonlinear spring adapted to be disposed in the outlet member and cooperating with the valve member to move the valve member to a closed position to engage the valve seat to prevent fuel from flowing through the outlet member and an open position spaced from the valve seat to allow fuel to flow through the outlet member.

### TECHNICAL FIELD

The present invention relates generally to fuel pumps for vehicles and, more particularly, to a check valve for a fuel pump of a vehicle.

### BACKGROUND OF THE INVENTION

It is known to provide a fuel tank in a vehicle to hold fuel to be used by an engine of the vehicle. It is also known to provide a fuel pump inside the fuel tank to pump fuel to the engine. Typically, the fuel pump includes a check valve to allow fuel to exit the fuel pump. Generally, a forward flow check valve consists of a checking device, typically a plunger, and a seat that when in contact form a leak proof seal. The plunger is forced against the seat with a spring that provides the proper force to maintain plunger to seat contact during low-pressure forward flow conditions. In automotive fuel pump applications, this force prevents flow from exiting the fuel tank when the vehicle fuel line is removed or severed. Linear springs have been used to apply a sealing force between the plunger and the seat. This force increases as the plunger travels away from the seat. The spring force required to maintain sealing during low-pressure forward flow conditions also creates an undesired flow restriction during high-pressure forward flow conditions.

To develop a low restriction flow path, the plunger must travel in the flow direction away from the seat. This creates a larger, less restrictive flow area between the seat and plunger. However, as the plunger travels away from the seat, the linear characteristic of the coil spring imparts additional force on the plunger and acts to resist the desirable increase in flow area.

Therefore, it is desirable to provide a check valve in a fuel pump for a vehicle that eliminates the use of coil springs. It is also desirable to provide a return spring in a check valve for a fuel pump without compromising low flow restriction. It is further desirable to provide a check valve for a fuel pump that produces the required plunger to seat contact force in the closed position, but reduces the counteracting force in the open position.

### SUMMARY OF THE INVENTION

It is, therefore, one object of the present invention to provide a new check valve for a fuel pump of a vehicle.

It is another object of the present invention to provide a new check valve for a fuel pump that has relatively low flow restriction.

To achieve the foregoing objects, the present invention is a check valve for a fuel pump of a vehicle including a valve housing adapted to be disposed in an outlet member of the fuel pump. The valve housing has a valve seat formed thereon. The check valve also includes a valve member adapted to be disposed in the outlet member and cooperating with said valve seat. The check valve further includes a nonlinear spring adapted to be disposed in the outlet member and cooperating with the valve member to move the valve member to a closed position to engage the valve seat to prevent fuel from flowing through the outlet member and an open position spaced from the valve seat to allow fuel to flow through the outlet member.

One advantage of the present invention is that a new check valve is provided for a fuel pump of a vehicle. Another advantage of the present invention is that the check valve uses a non-linear softening spring which acts on a plunger to provide low flow restriction and quiet or low noise operation. Yet another advantage of the present invention is that the check valve uses a non-linear softening spring which acts on a plunger to reduce the force applied as the plunger travels away from the seat, allowing an increase in flow area without a large increase in spring force to overcome. Still another advantage of the present invention is that the check valve has a relatively low cost and improves fuel pump performance and efficiency (lower current draw and higher flow) due to lower flow restriction through the check valve.

Other objects, features, and advantages of the present invention will be readily appreciated, as the same becomes better understood, after reading the subsequent description taken in conjunction with the accompanying drawings.

### BRIEF DESCRIPTION OF THE DRAWINGS

FIG. 1 is a fragmentary elevational view of a check valve, according to the present invention, illustrated in operational relationship with a fuel pump.

FIG. 2 is a fragmentary elevational view of the check valve of FIG. 1 illustrating a closed position.

FIG. 3 is a fragmentary elevational view of another embodiment, according to the present invention, of the check valve of FIG. 1 illustrating a closed position.

FIG. 4 is a fragmentary elevational view of yet another embodiment, according to the present invention, of the check valve of FIG. 1 illustrating a closed position.

FIG. 5 is a view similar to FIG. 4 illustrating an open position of the check valve.

FIG. 6 is a plan view of the check valve of FIG. 4.

FIG. 7 is a fragmentary elevational view of still another embodiment, according to the present invention, of the check valve of FIG. 1 illustrating a closed position.

### DESCRIPTION OF THE PREFERRED EMBODIMENT

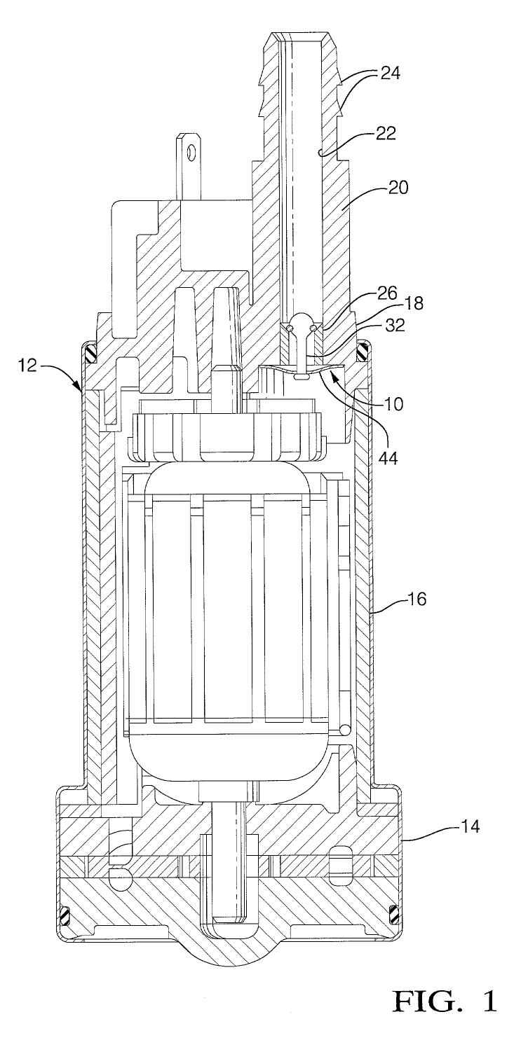

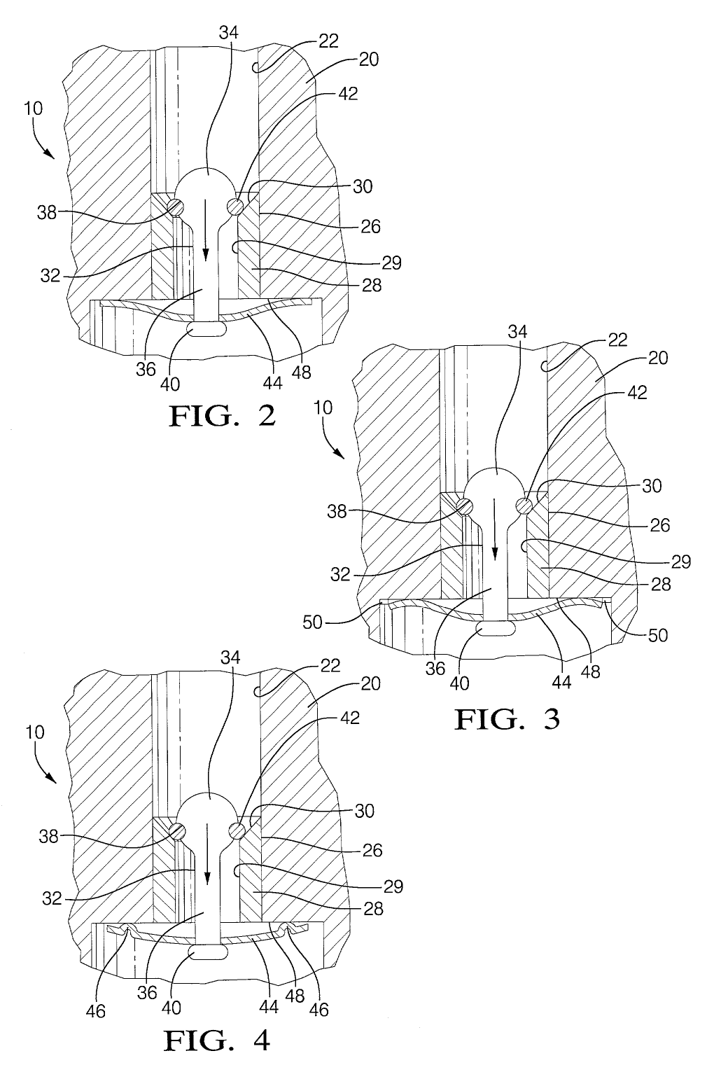

Referring to the drawings and in particular FIGS. 1 and 2, one embodiment of a check valve 10, according to the present invention, is shown for a fuel pump, generally indicated at 12, of a vehicle (not shown). The fuel pump 12 includes a pump section 14 at one axial end, a motor section 16 adjacent the pump section 14 and an outlet section 18 adjacent the motor section 16 at the other axial end. As known in the art, fuel enters the pump section 14, which is rotated by the motor section 16, and is pumped past the motor section 16 to the outlet section 18. The outlet section 18 has an outlet member 20 extending axially with a passageway 22 extending axially therethrough. The outlet member 20 also has a plurality of projections or barbs 24 extending radially outwardly for attachment to a conduit (not shown) . The outlet member 20 also receives the check valve 10 to be described in the passageway 22. It should be appreciated that the fuel flowing to the outlet section 18 flows into the outlet member 20 and through the passageway 22 and the check valve 10 when open to the conduit. It should also be appreciated that, except for the check valve 10, the fuel pump 12 is conventional and known in the art.

Referring to FIGS. 1 and 2, the check valve 10 includes a valve housing 26 extending axially and disposed in the passageway 22 of the outlet member 20. The valve housing 26 has a body portion 28 that is generally tubular in shape and has a generally circular cross-sectional shape. The body portion 28 extends axially and has a passageway 29 extending axially therethrough. The valve housing 26 has a valve seat 30 formed at one end of the body portion 28 and communicating with the passageway 29 for a function to be described. The valve housing 26 is made of a rigid material such as metal or plastic. The valve housing 26 is secured in the passageway 22 of the outlet member 20 by suitable means such as press-fitting. It should be appreciated that the valve housing 26 is a monolithic structure being integral, unitary, and one-piece.

The check valve 10 also includes a valve plunger or member 32 disposed in the passageway 29 of the valve housing 26 and cooperating therewith. The valve member 32 has a hub 34 and a stem 36 extending axially from the hub 34. The hub 34 has a generally spherical shape. The stem 36 has a generally cylindrical shape with a generally circular cross-section. The stem 36 has a diameter less than a diameter of the hub 34. The hub 34 has an annular groove 38 for a function to be described. The stem 36 has a flange 40 extending radially outwardly for a function to be described. The valve member 32 is made of a rigid material such as plastic.

The check valve 10 also includes a seal 42 disposed in the groove 38 to contact the valve seat 30. The seal 42 is of an o-ring type being annular with a generally circular cross-sectional shape. The seal 42 is made of an elastomeric material.

The valve member 32 has a first or closed position engaging the valve seat 30 to close the passageway 29 of the valve housing 26 as illustrated in FIG. 2. The valve member 32 has a second or open position spaced axially from the valve seat 30 to open the passageway 29 of the valve housing 26. It should be appreciated that fluid such as fuel flows through the passageway 29 in the valve housing 26, past the valve member 32 and through the passageway 22 of the outlet member 20 when the valve member 32 is in the open position.

The check valve 10 further includes a spring 44 to urge the valve member 32 toward the valve seat 30. The spring 44 is of a non-linear type. The spring 44 is generally rectangular in shape. The spring 44 is disposed about the stem 36 of the valve member 32 adjacent the flange 40. The spring 44 extends radially and has radial ends that engage a seated reaction point or surface 48 on the outlet member 20. Alternatively, a reaction surface may be provided as part of the body position 28 such that a completely operable valve is provided as an integral unit. It should be appreciated that the spring 44 urges the seal 42 on the hub 34 of the valve member 32 to engage the valve seat 30 in a closed position. It should also be appreciated that the spring 44 has its highest force in the seated or closed position and this force becomes less as the valve member 32 moves off the valve seat 30, effectively increasing the distance between the spring reaction points.

In operation, the check valve 10 is illustrated in an assembled state in which the valve housing 26 is disposed in the passageway 22 of the outlet member 20 of the fuel pump 12. The valve member 32 engages the valve seat 30 in the closed position as illustrated in FIG. 2. It should be appreciated that the valve member 32 is seated on the valve seat 30 by the non-linear softening spring 44 attached to the valve member 32.

Fuel enters the outlet member 20 when the fuel is pumped by the pump section 14 past the motor section 16 to the outlet section 18. In the check valve 10, fuel flows to the passageway 29 in the valve housing 26. As the pump section 14 builds pressure to overcome the spring seating force, the valve member 32 moves axially away from the valve seat 30 enlarging the flow area and becoming less restrictive to allow fuel to flow through the passageway 29 of the valve housing 26 and around the valve member 32. The movement of the valve member 32, in turn, displaces the spring 44, which decreases the force acting on the valve member 32, resulting in an overall lower restriction. Fuel flows from the check valve 10 through the passageway 22 of the outlet member 20 to the conduit. It should be appreciated that the spring 44 produces the required plunger to seat contact force in the closed position, but reduces the counteracting force in the open position. It should also be appreciated that the nonlinear softening spring 44 allows the valve member 32 to be designed with a low restriction streamline geometry, but still provide the necessary spring force.

Referring to FIG. 3, another embodiment, according to the present invention, of the check valve 10 is shown. Like parts have like reference numerals. In this embodiment, the check valve 10 includes the spring 44 extending radially to engage a seated reaction point or surface 48 on the outlet member 20 and has radial ends that engage an open reaction point or surface 50 on the outlet member 20. The operation of the check valve 10 of FIG. 3 is similar to the check valve 10 of FIG. 1.

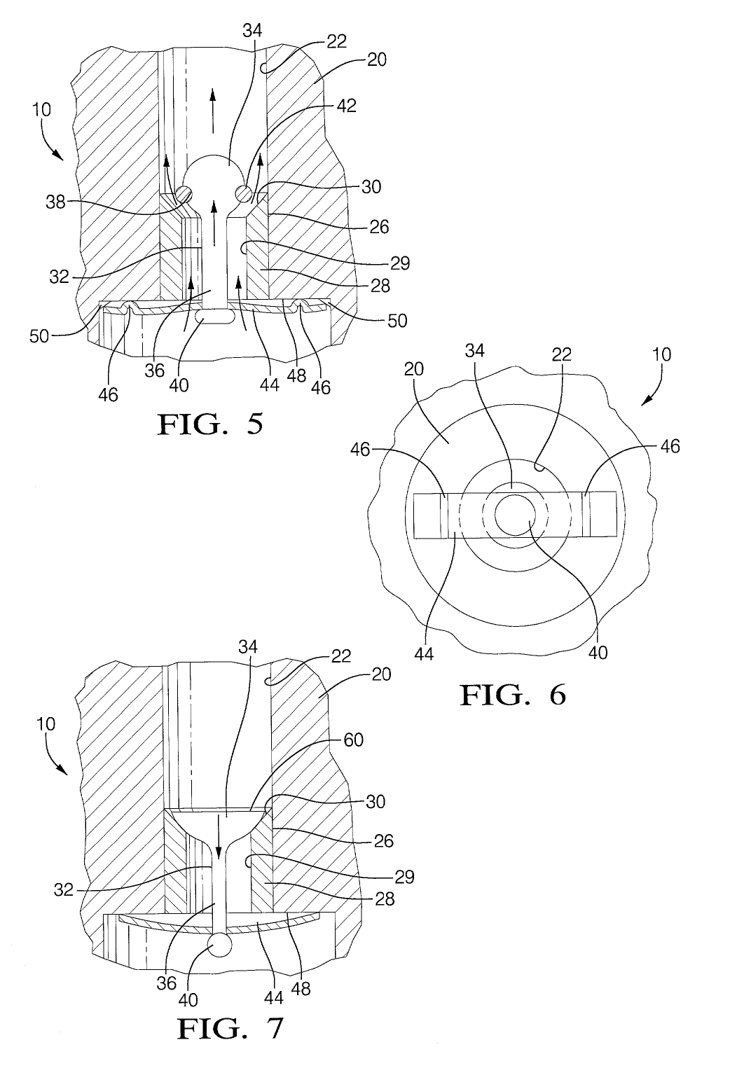

Referring to FIGS. 4 through 6, yet another embodiment, according to the present invention, of the check valve 10 is shown. Like parts have like reference numerals. In this embodiment, the check valve 10 includes the spring 44 extending radially and including at least one, preferably a plurality of seated reaction points or ribs 46 extending outwardly. The ribs 46 have a generally inverted “U” shape. The ribs 46 engage a seated reaction point or surface 48 on the outlet member 20 and the ends of the spring 44 engage an open reaction point or surface 50 on the outlet member 20. The operation of the check valve 10 of FIGS. 4 through 6 is similar to the check valve 10 of FIG. 1. It should also be appreciated that the spring 44 acts as a non-linear softening spring with a “step function”, allowing a relatively high seating force. It should also be appreciated that once the valve member 32 moves off the seat 30 and the spring 44 moves with it, the spring reaction points increase nonlinearly with movement of the spring 44, which greatly reduces the force acting against the valve member 32 in the open position of FIG. 5.

Referring to FIG. 7, still another embodiment, according to the present invention, of the check valve 10 is shown. Like parts have like reference numerals. In this embodiment, the check valve 10 eliminates the groove 38 and seal 42. The hub 34 of the valve member 36 has a flat or planar upper surface 60 and the hub 34 contacts and seals with the valve seat 30. The operation of the check valve 10 of FIG. 7 is similar to the check valve 10 of FIG. 1.

The present invention has been described in an illustrative manner. It is to be understood that the terminology, which has been used, is intended to be in the nature of words of description rather than of limitation.

Many modifications and variations of the present invention are possible in light of the above teachings. Therefore, within the scope of the appended claims, the present invention may be practiced other than as specifically described.

1. A check valve for a fuel pump of a vehicle comprising:
a valve housing adapted to be disposed in an outlet member of the fuel pump, said valve housing having a valve seat formed thereon;
a valve member adapted to be disposed in the outlet member and cooperating with said valve seat; and
a nonlinear spring adapted to be disposed in the outlet member and cooperating with said valve member to move said valve member to a closed position to engage said valve seat to prevent fuel from flowing through the outlet member and an open position spaced from said valve seat to allow fuel to flow through the outlet member.

2. A check valve as set forth in claim 1 wherein said spring extends radially and has radial ends adapted to engage a surface of the outlet member.

3. A check valve as set forth in claim 2 wherein said spring includes at least one rib extending axially and spaced radially from said radial ends adapted to engage the outlet member.

4. A check valve as set forth in claim 1 wherein said valve housing includes an aperture extending axially therethrough.

5. A check valve as set forth in claim 4 wherein said valve seat is a recess at an end of said valve housing and communicating with said aperture to receive and seat said valve member in said closed position.

6. A check valve as set forth in claim 4 wherein said valve member has a hub and a stem extending axially from said hub.

7. A check valve as set forth in claim 6 wherein said stem extends through said aperture and has a flange connected to said spring.

8. A check valve as set forth in claim 6 wherein said hub includes an annular groove.

9. A check valve as set forth in claim 8 wherein said valve member has a seal disposed in said groove.

10. A check valve as set forth in claim 6 wherein said hub has a generally spherical shape.

11. A check valve as set forth in claim 10 wherein said hub has a planar surface at one end.

12. A check valve for a fuel pump of a vehicle comprising:
a valve housing adapted to be disposed in an outlet member of the fuel pump, said valve housing having an aperture extending axially therethrough and a valve seat disposed at one end of said aperture of said valve housing;
a valve member having a hub cooperating with said valve seat and a stem extending axially from said hub and through said aperture of said valve housing; and
a nonlinear spring adapted to be disposed in the outlet member and attached to said stem of said valve member to move said valve member to a closed position to engage said valve seat to prevent fuel from flowing through the outlet member and an open position spaced from said valve seat to allow fuel to flow through the outlet member.

13. A check valve as set forth in claim 12 wherein said spring extends radially and has radial ends adapted to engage a surface of the outlet member.

14. A check valve as set forth in claim 13 wherein said spring includes a plurality of ribs extending axially and spaced radially from said radial ends adapted to engage the outlet member.

15. A check valve as set forth in claim 12 wherein said stem extends through an aperture and has a flange connected to said spring.

16. A check valve as set forth in claim 12 wherein said hub includes an annular groove.

17. A check valve as set forth in claim 16 wherein said valve member has a seal disposed in said groove.

18. A check valve as set forth in claim 12 wherein said hub has a generally spherical shape.

19. A check valve as set forth in claim 18 wherein said hub has a planar surface at one end.

20. A check valve for a fuel pump of a vehicle comprising:
a valve housing adapted to be disposed in an outlet member of the fuel pump, said valve housing having a body portion with an aperture extending axially therethrough and a valve seat disposed at one end of said aperture of said valve housing;
a valve member having a hub cooperating with said valve seat and a stem extending axially from said hub and through said aperture of said valve housing; and
a nonlinear spring connected to said stem and extending radially and having radial ends adapted to engage a surface of the outlet member and cooperating with said valve member to move said valve member to a closed position to engage said valve seat to prevent fuel from flowing through the outlet member and an open position spaced from said valve seat to allow fuel to flow through the outlet member.

21. A check valve comprising:
a valve housing having a valve seat formed thereon;
a valve member cooperating with said valve seat; and a nonlinear spring cooperating with said valve member to move said valve member to a closed position to engage said valve and an open position spaced from said valve seat.

22. A check valve as set forth in claim 21 wherein said spring extends radially and has radial ends adapted to engage a surface of the valve housing.

23. A check valve as set forth in claim 22 wherein said spring includes at least one rib extending axially and spaced radially from said radial ends adapted to engage the valve housing.

24. A check valve as set forth in claim 21 wherein said valve housing includes an aperture extending axially therethrough.

25. A check valve as set forth in claim 24 wherein said valve seat is a recess at an end of said valve housing and communicating with said aperture to receive and seat said valve member in said closed position.

26. A check valve as set forth in claim 24 wherein said valve member has a hub and a stem extending axially from said hub.

27. A check valve as set forth in claim 26 wherein said stem extends through said aperture and has a flange connected to said spring.

28. A check valve as set forth in claim 26 wherein said hub includes an annular groove.

29. A check valve as set forth in claim 28 wherein said valve member has a seal disposed in said groove.

30. A check valve as set forth in claim 26 wherein said hub has a generally spherical shape.

31. A check valve as set forth in claim 30 wherein said hub has a planar surface at one end.
